(19) United States
(12) Patent Application Publication
(10) Pub. No.: US 2012/0266903 A1
(43) Pub. Date: Oct. 25, 2012

(54) InstaBangs Attachable Hair Accessory

(76) Inventor: Noelle M. Devlin, Phoenix, AZ (US)

(21) Appl. No.: 13/445,908

(22) Filed: Apr. 12, 2012

Related U.S. Application Data
(60) Provisional application No. 61/517,105, filed on Apr. 13, 2011.

(51) Int. Cl. A41G 5/00; A01K 29/00

(52) U.S. Cl. 132/54; 119/174

(57) ABSTRACT

The invention provides a bang hair extension secured along the crown line by means of a lightweight and flexible hair comb, thus creating the illusion of stylish bangs, without requiring the commitment of actually cutting the hair. The invention also provides a bang hair extension having embellishments along the spine of the comb. The invention also provides a bang hair extension for use by non-humans, for example, by pets such as dogs.

### CLAIM OF PRIORITY

This patent application claims priority under 35 USC 119 (e) (1) from U.S. Provisional Patent Application Ser. No. 61/517,105 filed Apr. 13, 2011, of common inventorship herewith entitled, “InstaBangs Attachable Hair Accessory.”

### FIELD OF THE INVENTION

The present invention pertains to the field of beauty supplies, and more specifically to the field of attachable hair extensions.

### BACKGROUND OF THE INVENTION

The prior art has put forth several designs for attachable hair extensions. Among these are:

US Patent 2007/0157941 to Albeir Awad and Urei Wakisaka describes a detachable hair bang adapted to promote air flow during use. The base is cut in an arcuate configuration comprised of first and second sides. The first side is made of a non coated monofilament material. The second side is made of a coated monofilament material for smoothness and comfort when applied to one's forehead. Three toupee clips are stitched to the second side. The first and second sides define a front convex edge. A first set of hair strands is hand knotted into the front convex, one hair strand at a time to promote a natural look for the base. A second set of hair strands are hand knotted into the non coated monofilament first side, one to four hair strands at a time.

U.S. Pat. No. 4,819,671 to Lindsey J. Walker describes a hair accessory comprising a fringe connected to a head band attachment for securing the fringe to one's head. The fringe overlies the user's forehead and may comprise real or synthetic hair, material strips, or strings of beads. The fringe may have a plurality of layers and may be in various colors and patterns. These layers may be cut in various designs across the forehead, or color layers may be cut out to expose different color layers underneath each layer.

U.S. Pat. No. Des. 4,016,889 to Mary M. Cowles describes a hairpiece in the form of an elongated strip of natural or synthetic hair to be attached to one's natural hair to form bangs or to add fullness to existing bangs. The strip comes in all hair colors and is either sewn or glued underneath one's front hair line.

None of these prior art references describe the present invention.

### SUMMARY OF THE INVENTION

It is an object of the present invention to provide a bang hair extension secured along the crown line by means of a lightweight and flexible hair comb, thus creating the illusion of stylish bangs, without requiring the commitment of actually cutting the hair.

It is a further object of the present invention to provide a bang hair extension having embellishments along the spine of the comb.

It is a still further object of the present invention to provide a bang hair extension for use by non-humans, for example, by pets such as dogs.

### BRIEF DESCRIPTION OF THE DRAWINGS

FIG. 1 is five perspective views of the present invention showing one underside view of the comb attached to the hair bangs and four top views of the hair bangs in different colors and thicknesses.

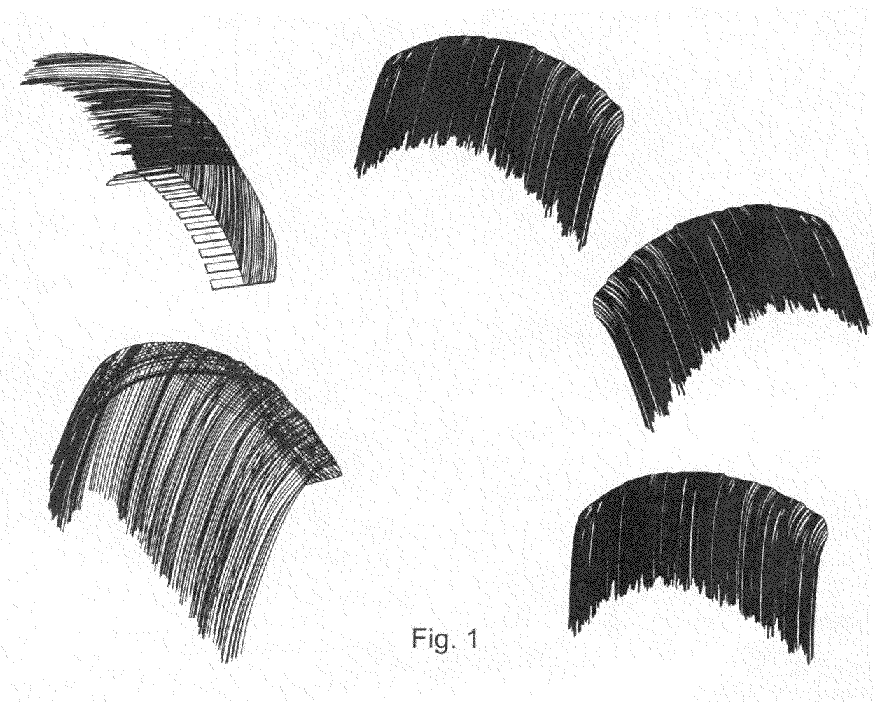

### DETAILED DESCRIPTION OF THE INVENTION

Throughout history men and women have worn wigs and hairpieces as a practical alternative for natural hair. In ancient Egypt people from all classes shaved their heads to remain comfortable in the intense African heat and donned long black wigs for social and ceremonial events. These early wigs were made from palm and wool fibers, animal or human hair and were adorned with gold, silver and lapis beads. In ancient Rome, fashionable women wore long blonde wigs. In France King Louis VIII began to wear elaborate hair pieces and wigs, and the trend spread to men throughout Europe and the New World. In our current culture, hair pieces and extensions are worn for a variety of reasons. It may be a simple toupee worn by a man suffering premature baldness, a finely crafted wig worn by a woman who has lost her hair as a result of chemotherapy treatments or alopecia, or colorful hair extensions and braids which adorn one's head for style and fashion. Wigs, hairpieces and extensions offer consumers a simple means of accentuating their appearance and feeling good about themselves.

The present invention, hereinafter referred to as the InstaBangs, is a specially designed line of extensions configured in the form of bangs, to be applied along the crown line by means of a lightweight and flexible hair comb, thus creating the illusion of stylish bangs without requiring the commitment of actually cutting the hair. The InstaBangs also provide those who suffer hair loss with a practical way to camouflage thinning hair and create the illusion of a thick, full head of hair.

Manufactured of synthetic or human hair, the InstaBangs will be produced in a wide range of shades designed to match the most popular hair colorants available on the market, as well as the various shades of natural hair coloring. Designed to perfectly blend with the wearer's natural hair, these unique hairpieces can be produced in fine, medium and thick versions, and short, medium and long lengths as well as straight, wavy and curly textures.

InstaBangs will be secured to a lightweight and flexible hair comb measuring approximately one centimeter in width and featuring durable gripping tines designed to easily secure the unit in place. Adhesive backed extensions can also be made available.

InstaBangs come in sizes small, medium and large, and are available in hair types to match all ethnicities. They are available in styles and designs to suit children and adults. The embellished InstaBangs can have a myriad of decoration such as studs, rhinestones, other jewelry effects, real jewels, ribbon, bows, and charms, for example all decorated along crown line.

Fun and funky bangs, produced in brilliant hues of purple, pink, blue, yellow green or orange are also available, providing consumers a novel way in which to accentuate a particular hair style.

Application and use of the InstaBangs is very simple and straight forward. Professional stylists or general consumers purchase the extensions to be utilized in a salon or at home. Holding the InstaBangs in hand, the user applies the device directly to the scalp at the crown or part via the integrated hair comb. After the InstaBangs have been attached, the user styles their hair as usual, setting the style with a light spritz of finishing spray. The user removes the InstaBangs before shampooing and conditioning their hair. The InstaBangs can be cleaned and used again or the user can apply new InstaBangs extensions.

The InstaBangs provide consumers with a unique and stylish accessory for the hair and enables consumers to easily create any number of stylish looks without having to cut their hair. Ideal for adding a new dimension of fun to one's current hairstyle, these unique extensions also are useful for creating the appearance of a full and thick head of hair along one's crown and part. The InstaBangs is an easy to use hair accessory hair which can be effortlessly applied directly to the scalp with a discreetly hidden hair comb. The InstaBangs will be manufactured in a wide array of colors, textures and styles, so the wearer can perfectly match the hair piece to their own natural hair or existing extensions. The InstaBangs can be shampooed, styled and conditioned in the same manner as the wearer's own natural hair. The InstaBangs can be curled, flat ironed or crimped for the wearer to enjoy a variety of hairstyles with one simple hair piece. The affordable InstaBangs will be well received by anyone who enjoys wearing natural or synthetic extensions.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A bang hair extension device attached with a lightweight and flexible hair comb, wherein the extensions are configured in the form of bangs, and are applied along the crown line thus creating the illusion of stylish bangs without requiring the commitment of actually cutting the hair.

2. The device of claim 1 also comprising embellishment along the crown line of the comb.

3. The device of claim 1 manufactured of synthetic or human hair, and are produced in a wide range of shades designed to match the most popular hair colorants available on the market, as well as the various shades of natural hair coloring.

4. The device of claim 1, produced in fine, medium and thick versions, and short, medium and long lengths and straight, wavy and curly textures.

5. The device of claim 1 wherein the comb measures approximately one centimeter in width and features durable gripping tines designed to easily secure the device in place.

6. A bang hair extension device attached with an adhesive strip, wherein the extensions are configured in the form of bangs, and are applied along the crown line thus creating the illusion of stylish bangs without requiring the commitment of actually cutting the hair.

7. The device of claim 1 made in sizes small, medium and large, and are available in hair types to match all ethnicities.

8. The device of claim 1 available in styles and designs to suit children and adults.

9. The device of claim 2 wherein the embellishment comprises a myriad of decoration such as studs, rhinestones, other jewelry effects, real jewels, ribbon, bows, and charms, decorated along crown line.

10. The device of claim 1 comprising fun and funky bangs, produced in brilliant hues of purple, pink, blue, yellow green or orange.

11. The device of claim 1 configured for use on non-humans, such as dogs.
